(19) United States
(12) Patent Application Publication
(10) Pub. No.: US 2019/0013529 A1
(43) Pub. Date: Jan. 10, 2019

(54) GASKET FOR MOLTEN CARBONATE FUEL CELL, WITH OXIDE-BASED ELECTROLYTE TRANSPORT-BLOCKING LAYER FORMED THEREIN

(71) Applicants: POSCO, Gyeongsangbuk-do (KR); RESEARCH INSTITUTE OF INDUSTRIAL SCIENCE & TECHNOLOGY, Gyeongsangbuk-do (KR)

(72) Inventors: Ji-Woong MOON, Gyeongsangbuk-do (KR); Sung-Yon LEE, Gyeongsangbuk-do (KR); Jong-Hoon YOON, Gyeongsangbuk-do (KR)

(21) Appl. No.: 16/065,719

(22) PCT Filed: Dec. 23, 2016
(86) PCT No.: PCT/KR2016/015249

§ 371 Date: Jun. 22, 2018

(30) Foreign Application Priority Data
Dec. 24, 2015 (KR) 10-2015-0186477

(51) Int. Cl. H01M 8/0276; H01M 8/124; H01M 8/242; H01M 8/0286; H01M 8/028

(52) U.S. Cl. CPC H01M 8/0276; H01M 8/124; H01M 8/028; H01M 8/0286; H01M 8/242

(57) ABSTRACT

The present disclosure relates to a gasket for an MCFC, the gasket being in direct contact with a molten carbonate electrolyte and configuring a wet seal part of a stack in a manifold sealing part of an external manifold-type MCFC stack, wherein the gasket has a structure in which two or more partial gaskets separated from each other in a stacking direction of the stack are connected to each other and a blocking layer physically blocking migration of the molten carbonate electrolyte is formed between the partial gaskets, and the blocking layer is a thick film layer or a green sheet layer formed of the same oxide powder particles as those of the partial gaskets and is manufactured by co-sintering a partial oxide felt assembly and the blocking layer in a process of sintering the gasket.

### TECHNICAL FIELD

The present disclosure relates to a gasket used for sealing a manifold of an external manifold-type molten carbonate fuel cell (MCFC), and more particularly, to a gasket having an electrolyte migration-blocking layer for preventing a phenomenon in which a molten carbonate electrolyte impregnated in a matrix migrates from a positive electrode end of a stack to a negative electrode end thereof through the gasket, and a method of manufacturing the same.

Further, the present disclosure relates to a manifold sealing part and a molten carbonate fuel cell including the gasket, and relates to a method of forming the manifold sealing part.

### BACKGROUND ART

In an external manifold-type molten carbonate fuel cell (MCFC), a manifold sealing part performing gas sealing and insulation maintaining between a manifold supplying fuel and air and formed of a metal and a stack is required. The manifold sealing part includes a gasket indirect contact with the stack to provide a gas sealing function and a dielectric providing an insulation function between the gasket and the manifold formed of the metal while mechanically supporting the gasket and the manifold between the gasket and the manifold.

The gasket, a component forming gas sealing between the stack and the manifold, performs a gas sealing role, an insulating role, and a buffering role between the stack and the manifold using an oxide felt as a basic material. However, the gasket is structurally porous, and thus becomes a migration path of a liquid electrolyte during an operation of the MCFC.

In the MCFC stack, several hundreds of end cells are connected to one another in series, and a direct current (DC) voltage of several hundreds of volts is thus applied between a positive electrode end and a negative electrode end during the operation of the MCFC. The DC voltage becomes driving force, such that positive ions such as Li⁺, K⁺, Na⁺, and the like, which are positive ion components of a molten carbonate electrolyte wetted in a material of the porous gasket, migrate from the positive electrode end to the negative electrode end, and CO₃²⁻ ions migrate toward the positive electrode end.

The electrolyte migration amount is significantly changed depending on the material of the gasket and a fine structure control method, and after the MCFC stack is driven for a long period of time, because of an “electrolyte migration phenomenon,” a performance decrease and gas leakage are generated due to lack of the electrolyte in a cell of the positive electronic end, and performance is rapidly decreased due to an electrolyte excess state in a cell of the negative electrode end. Therefore, the gasket needs to basically have sealing performance, and needs to minimize the electrolyte migration amount therethrough.

In an initial MCFC product, a ZeO₂-based felt has been used, but the electrolyte migration amount through the gasket is large, which causes a stack lifespan decrease. In order to solve such a problem, a CeO₂-based felt is used instead of the ZeO₂-based felt, such that the electrolyte migration amount is significantly decreased as compared to the zirconia-based felt. However, it is still difficult to achieve a stack lifespan of ten years for securing profitability of the MCFC to a stack lifespan of twenty years, a grid parity achievement level.

Currently, in order to alleviate such a phenomenon, a high fill cell of which a molten carbonate support amount is large is used in a positive electrode in which an electrolyte is depleted, and a low fill cell of which a molten carbonate support amount is small and a capacity is increased so as to support the electrolyte migrating from the positive electrode is separately manufactured in a negative electrode to cope with the stack lifespan decrease due to the “electrolyte migration phenomenon.” However, for the reason described above, a stack structure becomes complicated, and separate cells other than standard specifications need to be produced and managed, which is inefficient. In addition, when a stack lifespan of eighty thousand to one hundred thousand hours required to secure price competitiveness through a decrease in a replacement cost of the stack required for ensuring a system lifespan of about twenty years generally demanded by a power generation company is considered, a more fundamental solution is required.

### DISCLOSURE

### Technical Problem

An aspect of the present disclosure is to provide a gasket capable of preventing a molten carbonate electrolyte impregnated in a matrix from migrating from a positive electrode end to a negative electrode end through the gasket, and a method of manufacturing the same.

Another aspect of the present disclosure is to provide a manifold sealing part including the gasket, and a method of manufacturing the same.

Another aspect of the present disclosure is to provide a molten carbonate fuel cell.

### Technical Solution

According to an aspect of the present disclosure, a gasket for an external manifold-type molten carbonate fuel cell (MCFC) is in direct contact with a matrix of an external manifold-type MCFC stack in a manifold sealing part of the external manifold-type MCFC stack, and has a structure in which two or more partial gaskets separated from each other in a stacking direction of the stack are connected to each other and a blocking layer physically blocking migration of a molten carbonate electrolyte between the partial gaskets is formed. The blocking layer may be formed of a dense oxide material. The blocking layer may be formed of the same material as that of the partial gasket.

The blocking layer may be installed in parallel with a stacking surface of the stack or be installed to be inclined with respect to the stacking surface of the stack to have an inclination. To this end, in a case of cutting an oxide felt assembly, a raw material, in a process of manufacturing the partial gasket, the oxide felt assembly may be cut in a direction perpendicular to a length direction of the gasket or be cut at a predetermined angle with respect to the length direction of the gasket (see FIG. 4).

The blocking layers as many as possible may be installed in the stacking direction of the stack, and the partial gasket may have a length of 2 to 5 cm. In addition, the blocking layer may have a thickness of 0.1 to 0.3 mm.

According to another aspect of the present disclosure, a method of manufacturing a gasket for forming the blocking layer may include: manufacturing an oxide felt assembly by bonding felts formed of an oxide material corresponding to a raw material to each other and stacking the felts; manufacturing partial oxide felt assemblies by cutting the oxide felt assembly at an appropriate size; forming oxide powder layers on cut surfaces of the partial oxide felt assemblies; connecting the partial oxide felt assemblies on which the oxide powder layers are formed to one another; and manufacturing the gasket by co-sintering the connected partial oxide felt assemblies while applying a load to the connected partial oxide felt assemblies, wherein a material of the blocking layer is a paste of oxide powder particles or a green sheet of the oxide powder particles.

In FIG. 5, an example in which dense oxide (CeO₂) layers are formed as the blocking layers on porous partial gaskets (CeO₂ felt sintered bodies) through the co-sintering is illustrated.

According to another aspect of the present disclosure, a manifold sealing part in which the gasket for an MCFC having the blocking layer formed thereon is manufactured to have a predetermined width and length and is attached to a dielectric supporting the gasket may be provided.

According to another aspect of the present disclosure, a method of forming a manifold sealing part may be provided, wherein the manifold sealing part is manufactured by attaching the manufactured gasket for an MCFC to the dielectric.

The dielectric may be an insulator formed of alumina having a purity of 99.5% or more.

According to another aspect of the present disclosure, a molten carbonate fuel cell in which the manifold sealing part is disposed between an external manifold and a stack may be provided.

### Advantageous Effects

As set forth above, according to an exemplary embodiment in the present disclosure, in a fuel cell for an MCFC, a gasket may be divided into a plurality of stages in a stacking direction of a stack, and blocking layers capable of hindering migration of an electrolyte may be formed between the respective stages to physically block migration of a molten carbonate electrolyte from a positive electrode end plate toward a negative electrode end plate.

Particularly, in the related art, the blocking layer is formed in a process of stacking the stack, such that a process of installing the gasket is complicated, and when an error occurs in an array or a position of the blocking layer, it may be difficult to accomplish an effect of the blocking layer in the stack. However, in the present disclosure, the blocking layer is formed in the gasket in a process of sintering the gasket, such that the same process as that of the integral gasket according to the related art that does not have the blocking layer may be performed, and the gasket may thus be very effectively applied in terms of a process and economy.

In addition, in the related art, a material having a high possibility of a chemical reaction to the molten carbonate, such as an insulation-coated metal, or the like, is suggested as a material of the blocking layer, while in the present disclosure, the oxide material that is used as a material of the gasket, does not form a chemical reaction product to the molten carbonate, the electrolyte, at an MCFC use temperature, and is confirmed in terms of stability may be used as the material of the blocking layer to maintain an effect of the blocking layer for a long period of time. A representative example of the oxide material may be CeO₂, and may include other oxide materials that do not react to the molten carbonate, and mixtures thereof.

An electrolyte migration amount of the MCFC stack may be significantly decreased, improvement of a long-term lifespan of the stack may be promoted, and designs of the stack and the cell may be simply implemented, such that price competitiveness of an MCFC system may be significantly improved.

### DESCRIPTION OF DRAWINGS

FIG. 1 is a schematic structure illustrating a general structure of an external manifold-type molten carbonate fuel cell (MCFC) including a fuel cell stack including a gasket.

FIG. 2 is a schematic view illustrating comparison between a structure of a gasket according to the present disclosure in which blocking layers are inserted between partial gaskets and the related art.

FIG. 3 is a schematic view illustrating a method of manufacturing a gasket according to the present disclosure and terms used in the present disclosure.

FIG. 4 is a schematic flow chart illustrating processes of manufacturing a gasket according to the present disclosure.

FIG. 5 is a view illustrating a sealing concept of an MCFC manifold to which a sealing part including partial gaskets having electrolyte migration-blocking layers according to the present disclosure is applied.

FIG. 6 is microstructure photographs of an example in which an oxide (CeO₂) blocking layer is coupled to porous partial gaskets through co-sintering.

FIG. 7 is a view illustrating a shrinkage percentage of a gasket in which blocking layers according to the present disclosure are formed.

FIG. 8 is a view illustrating a method of testing an effect of electrolyte migration-blocking layers according to the present disclosure.

FIG. 9 is a view illustrating electrolyte migration-blocking effects of Inventive Example 1 and Comparative Example 1 tested by the method of FIG. 8.

### BEST MODE FOR INVENTION

The present disclosure provides a gasket for an external manifold-type molten carbonate fuel cell (MCFC), in direct contact with a matrix of an external manifold-type MCFC stack in a manifold sealing part of the external manifold-type MCFC stack as an example, and the gasket has a structure in which two or more partial gaskets separated from each other in a stacking direction of the stack are connected to each other and a blocking layer physically blocking migration of molten carbonate, an electrolyte, between the partial gaskets is formed.

### MODE FOR INVENTION

Hereinafter, exemplary embodiments in the present disclosure will be described with reference to the accompanying drawings. However, exemplary embodiments in the present disclosure may be modified in several other forms, and the scope of the present disclosure is not limited to exemplary embodiments to be described below.

In describing the present exemplary embodiments, the same components are described using the same names, and an overlapping additional description therefor is thus omitted. The accompanying drawings are not illustrated to scale.

An implementation in the present disclosure is to suppress migration of an electrolyte by improving a structure of a gasket used in a contact part in direct contact with side surfaces of a matrix, a wet seal part, a reforming unit of a bipolar plate, and the like, which are repeating components of a stack, in a molten carbonate fuel cell.

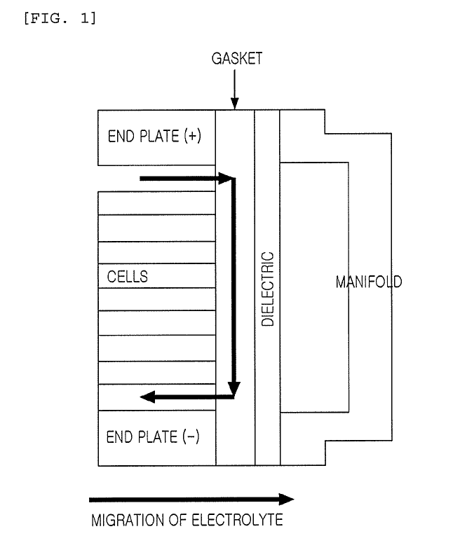

FIG. 1 is a schematic structure illustrating a general structure of an external manifold-type molten carbonate fuel cell (MCFC) including a fuel cell stack including a gasket. As illustrated in FIG. 1, the stack of the external manifold-type MCFC is configured by stacking a plurality of fuel cells. The stack has a gasket and an external manifold disposed in a sandwich form on a side surface thereof, and has end plates stacked at upper and lower portions thereof.

The external manifold-type MCFC as described above includes a manifold sealing part maintaining gas sealing and insulation between the manifold supplying fuel and air and formed of a metal and the stack. The manifold sealing part includes a gasket in direct contact with the stack and a dielectric mechanically supporting the gasket and providing an insulation property.

The gasket, the sealing part including the gasket, and methods of manufacturing the gasket and the sealing part according to the present disclosure are described.

In the manifold sealing part, the dielectric is disposed between the manifold formed of the metal and the stack to secure an electrical insulation property between the manifold and the stack, and the gasket is disposed between the manifold and the stack. When a predetermined surface pressure is applied, the gasket is deformed to fill a gap between the stack and the manifold, thereby forming the gas sealing. Flatness of the manifold and an insulator may be secured through surface machining, but portions in contact with the manifold and the insulator are edge portions of the stack in a state in which several hundreds of different components such as a matrix, a separator, and the like, are stacked, and it is impossible to form perfect flat surfaces by allowing end portions of all the repeating components to coincide with one another in a process of manufacturing and stacking the stack. Further, when the stack is driven for a long period of time, growth of a metal separator is generated, and since growth levels are different from one another at each of positions of the stack, the edge portions of the stack may not be perfect flat surfaces.

Therefore, it is preferable that a gasket material sealing a space between the insulator and the stack is a material that is deformable to fill the gap between the edge portion of the stack and the gasket, is stable under air and fuel gas of 600 to 700° C. or more, and has very low electrical conductivity. As a typical material satisfying the physical properties described above, an oxide felt or textile, for example, a zirconia felt, a ceria (CeO₂) felt, or the like, is used.

Since these materials have a relative density of 20% or less and a fibrous structure, when pressure is applied to these materials, these materials may be deformed to fill the gap between the edge portion of the stack and the insulator, thereby suppressing leakage of gases of a cathode and an anode through the gap.

Since it is difficult to commercially obtain an oxide gasket material or an oxide felt material that is singly in charge of an entire length of a commercial MCFC stack generally having a height of 3 m or more, gaskets having a length of several tens of centimeters are connected to one another in a vertical direction to be in charge of the entire length of the commercial MCFC stack from a positive electrode end to a negative electrode end in a stacking direction of the stack.

For example, in a case of ceria felts used as a raw material of the gasket, a currently commercially available felt is a product manufactured by Zircar Zirconia Inc. of the United States and having a thickness of 0.01 inches, a length of 12 inches, and a width of 12 inches. Therefore, the gasket is generally manufactured at about 30 cm, and is cut and used at an appropriate width and length at the time of stacking the stack. In this case, connection parts between the gaskets are obliquely cut and are then disposed to overlap one another to suppress generation of leakage of the gas through a joint. Therefore, actually, the stack has a structure in which the gaskets are continuously connected to one another from the positive electrode end to the negative electrode end in the vertical direction.

The gasket is in contact with stack components such as the separator, the matrix, and the like. In this case, in the matrix, carbonate, an electrolyte, is molten during conditioning the stake to form a dense gas sealing part while filling pore, known as wet sealing. When the wet sealing is formed, the molten carbonate electrolyte filling the matrix is in contact with the gasket that is porous through a contact part of the gasket, and when the conditioning of the stack ends and driving of the stack starts, an electrolyte “migration” phenomenon in which molten carbonate electrolyte of a matrix of the positive electrode end migrates to the negative electrode end through the gasket by a potential difference of several hundred volts applied between the positive electrode end and the negative electrode end occurs. When the electrolyte migration phenomenon is continued for a long period of time, an electrolyte lack phenomenon occurs in the matrix of the positive electrode end, such that cross-over of fuel and air, that is, leakage of the fuel and the air occurs, and cell performance is significantly decreased due to an electrolyte excess phenomenon in a matrix of the negative electrode end.

In the related art, in manufacturing the gasket, for example, a method of stacking several (four to six) CeF-100 felts having a thickness of 0.1 inches and manufactured by Zircar Zirconia Inc. of the United States in a thickness direction and then sintering the several CeF-100 felts in a temperature range of 1600 to 1700° C. to bond the felts to one another and at the same time, controlling microstructures of raw material ceria felts by high temperature heat treatment to decrease an amount of absorbed molten carbonate and give a mechanical property appropriate for being used as an MCFC gasket is used.

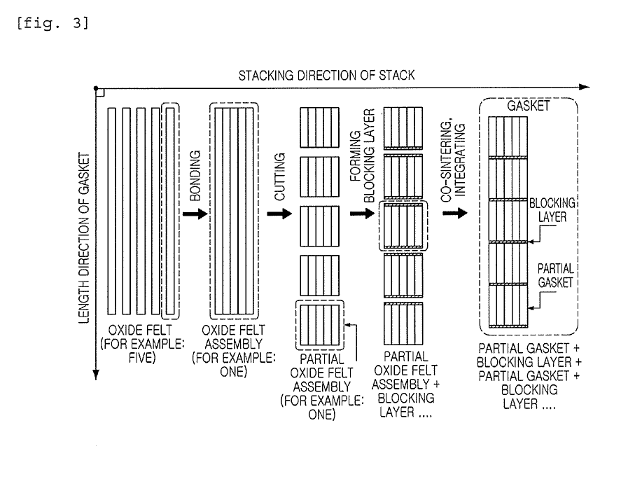

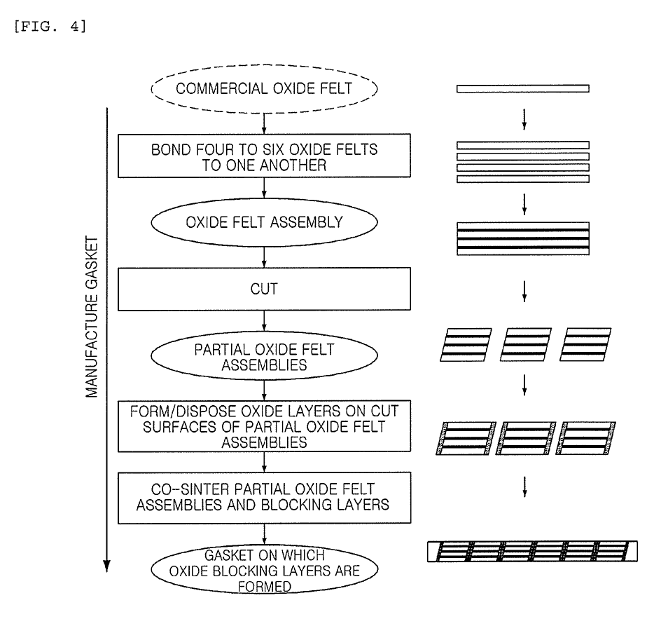

Prior to a detailed description of the present disclosure, terms used in a detailed description of a method of manufacturing a gasket according to the present disclosure are schematically summarized in FIGS. 3 and 4. First, a product obtained by bonding several oxide felts to one another by organic adhesives is referred to as an “oxide felt assembly.” A product obtained by cutting the oxide felt assembly in a direction perpendicular to a length of the gasket, that is, in parallel with the stacking direction of the stack is referred to as a “partial oxide felt assembly.” A dense layer formed on a cut surface of the “partial oxide felt assembly” and suppressing migration of a molten carbonate electrolyte is referred to as a “blocking layer.”

In addition, when a plurality of “partial oxide felt assemblies” on which a plurality of blocking layers are formed are connected to one another and are sintered to be integrated with one another, the plurality of “partial oxide felt assemblies” becomes a plurality of “partial gaskets,” and a finished product in which the plurality of “partial gaskets” and the blocking layers are integrated with one another in a length direction is referred to as a “gasket.”

In FIG. 4, processes of manufacturing the “gasket” are schematically illustrated.

In the present disclosure, in order to form the blocking layers blocking the migration of the electrolyte due to the potential difference between the positive electrode end and the negative electrode end, the respective oxide felts are bonded to one another using the organic adhesives in being stacked in the thickness direction, the oxide felt assembly is cut in the stacking direction of the stack (in a length direction on a side surface of the oxide felt assembly) to manufacture the partial oxide felt assemblies having a predetermined length, oxide powder layers are formed on cut surfaces of the partial oxide felt assemblies, and the partial oxide felt assemblies are connected to one another and are then sintered to complete an integrated oxide gasket. In this case, the blocking layers that may block the migration of the molten carbonate by forming dense oxide sintered bodies in the sintering process and are the oxide powder layers are formed on the cut surfaces of the partial oxide felt assemblies constituting the oxide gasket.

Through co-sintering, the partial oxide felt assemblies become the partial gaskets, and the blocking layers bond the partial gaskets to one another while being densified, such that the integrated oxide gasket is completed.

In addition, the oxide powder layers formed on the cut surfaces of the partial oxide felt assemblies are densified in the sintering process to serve as “electrolyte migration-blocking layers” capable of physically blocking the migration of the electrolyte. Therefore, the migration of the electrolyte in the length direction of the gasket may be suppressed.

The blocking layers are formed in a direction perpendicular to a migration direction of the electrolyte from the positive electrode end toward the negative electrode end to physically block the migration of the electrolyte. The shorter the length of the partial oxide felt assemblies cut at a predetermined length, the more the blocking layers may be formed. Therefore, the shorter the length of the partial oxide felt assemblies, the better the performance of the gasket.

However, when only one blocking layer is formed, an electrolyte migration phenomenon may be suppressed as compared to an existing gasket having a continuous and porous structure. Therefore, the shorter the length allowable in a manufacturing process at which the oxide felt assembly is cut, that is, the more the number of partial gaskets per unit length of the gasket completed after the co-sintering, in other words, the more the number of blocking layers, the better the electrolyte migration-blocking effect. Therefore, a distance between blocking layers needs to be optimized so that a plurality of blocking layers allowable in the manufacturing process per unit length may be formed. For example, one blocking layer per 2 to 5 cm may be formed in the co-sintered gasket, but the optimization of the distance between the blocking layers is not an essential element of the present disclosure.

The blocking layer formed between the oxide partial gaskets is required to have a dense structure capable of physically blocking the migration of the electrolyte through the gasket having the porous structure. Therefore, a fraction of penetration pores through which the molten carbonate electrolyte may pass needs to be minimized. More preferably, connected pores or cracks through which the molten carbonate electrolyte may pass do not exist at all, or even in a case in which a very small amount of connected pores or cracks exist, a fraction of the connected pores or cracks is very low and connectivity between the connected pores or cracks is bad, such that resistance to the migration of the molten carbonate by an electric field is very high.

The blocking layers are in contact with a fuel gas, water vapor, and carbon dioxide under the oxidizing/reducing atmosphere in a temperature range of 500 to 700° C. In addition, the blocking layers are in contact with a wet seal part of the MCFC, and thus need to be formed of a material of which stability is secured in a chemical reaction to the molten carbonate. Further, as the material of the blocking layer, a material thermally stable in the range of 500 to 700° C. and having an electrical insulation property or having an impedance very high than that of a unit cell of a molten carbonate fuel cell is required. Therefore, it is not preferable to use a polymer or a metal as the material of the blocking layer, and it is most preferable to use oxide materials, which are materials of an existing gasket, as the material of the blocking layer.

A material such as alumina, LiAlO₂, yttria-doped zirconia (Y₂O₃-doped ZrO₂), CeO₂, or the like, among the oxide materials may be used. An yttria-doped zirconia (Y₂O₃-doped ZrO₂) based material and a CeO₂ based material, which are used as raw materials of an MCFC manifold gasket in the related art are preferable materials. A CeO₂ material, an oxide that does not have reactivity to the molten carbonate, the electrolyte, is more preferable.

In a case of the gaskets according to the related art that do not have the blocking layer, a CeO₂ gasket manufactured by using CeO₂ felts as a raw material and stacking and sintering the CeO₂ felts is better than a gasket using yttria-doped zirconia (Y₂O₃-doped ZrO₂).

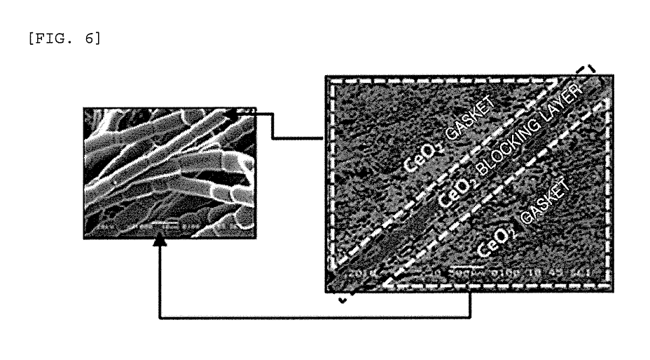

FIG. 6 is microstructure photographs of an example in which an oxide (CeO₂) blocking layer is coupled to porous partial gaskets through co-sintering.

In addition, it is preferable that the oxide material has the same composition as that of the oxide constituting the oxide felt assembly. For example, it is preferable that when an oxide felt, a raw material, is formed of yttria-doped zirconia (Y₂O₃-doped ZrO₂), yttria-doped zirconia (Y₂O₃-doped ZrO₂) is used as the material of the blocking layer, and when an oxide felt, a raw material, is formed of CeO₂, CeO₂ is used as the material of the blocking layer.

The reason is that this case may be free from a problem due to a chemical reaction between heterogeneous materials in the co-sintering process and it is advantageous that the partial gaskets and the blocking layer are formed of the same material when considering structural stability of bonded parts of the partial gasket-the blocking layer-the partial gasket.

It is important in implementing the spirit of the present disclosure that the partial gasket and the blocking layer constituting the integrated gasket manufactured by the co-sintering are robustly bonded to each other and the blocking layer is formed as densely as possible to minimize the migration of the molten carbonate through the penetration pores and penetration cracks in the blocking layer to maximize a migration suppressing effect of the molten carbonate penetrating through the blocking layer.

To this end, first, it is important to select the oxide material, and CeO₂ among the oxide materials is most preferable. The reason is that CeO₂ has no reaction to the molten carbonate and dissolution reaction and has the smallest electrolyte migration amount among the gaskets according to the related art that do not have the blocking layer. The spirit of the present disclosure is not limited to CeO₂, but may also be applied to various oxide materials such as yttria-doped zirconia (Y₂O₃-doped ZrO₂) and LiAlO₂.

Next, it is important to select a co-sintering temperature (a co-sintering temperature of the blocking layer and the partial oxide felt assembly). Since the co-sintering temperature of the gasket is an element determining a microstructure of the partial gasket except for the blocking layer, it is appropriate that the co-sintering temperature of the gasket is in a range of 1600 to 1700° C., more preferably, a range of 1600 to 1650° C. In this case, it is preferable that the co-sintering is performed in the atmosphere.

In addition, a very important spirit for accomplishing an object of the present disclosure is to manufacture the “oxide felt assembly” by bonding the oxide felts to each other using the organic adhesives before sintering the oxide felts, manufacture the “partial oxide felt assemblies” by cutting the oxide felt assembly, and form thick film layers or blocking layer constituting powder particles such as green sheets at a predetermined thickness on the cut surfaces of the partial oxide felt assemblies unlike the related art in which the oxide felts are stacked and are then bonded to each other by sintering to manufacture the gasket and the blocking layer is formed.

For example, when the CeF-100 felts manufactured by Zircar Zirconia Inc. of the United States are sintered at 1600 to 1650° C. in the process described above, they are linearly shrunk by about 36 to 38% in a thickness direction and by about 12 to 15% in a width direction. In order to sufficiently densify the blocking layer constituting powder particles at the co-sintering temperature, the blocking layer formed of the oxide powder particles needs to be able to be sufficiently sintering-shrunk in the co-sintering process using the shrinkage percentage.

Even though the blocking layer having the same composition is formed in the gasket in which the oxide felts are sintered in the range of 1600 to 1650° C. according to the related art, the completed gasket is not sintering-shrunk any more and hinders the densification of the blocking layer, and it is thus impossible to form a dense sintered body that does not include continuous pores or cracks in an atmospheric pressure sintering manner at 1600 to 1650° C., an optimal temperature of the co-sintering.

Therefore, it is very important in the present disclosure that the partial oxide felt assemblies and the blocking layers have sufficient shrinkage percentages at the time of being co-sintered and temperature profiles of sintering-shrinkage of the respective layers, that is, the partial oxide felt assemblies and the blocking layers need to be similar to each other. To this end, it is important to select CeO₂ powder particles constituting the blocking layer.

When an average particle size of the blocking layer constituting powder particles, for example, the CeO₂ powder particles is excessively large, it is difficult to densify the blocking layer constituting powder particles in the range of 1600 to 1650° C., a co-sintering optimal temperature range. In this case, a plurality of penetration pores and cracks are generated in the co-sintered blocking layer. On the other hand, when an average particle size of the blocking layer constituting powder particles is excessively small, sintering-shrinkage is generated at a temperature lower than that of the CeO₂ felt (for example, CEF-100 manufactured by Zircar Zirconia Inc. of the United States) constituting the partial oxide felt assembly and is completed at a temperature lower than that of the CeO₂ felt, and the partial gasket and the blocking layer may thus be separated from each other on an interface therebetween. In the present disclosure, it is preferable that an appropriate size of CeO₂ particles is 0.5 μm or more to 3 μm or less in terms of an average particle size.

In addition, it is preferable to dispose a plurality of partial oxide felt assemblies and oxide powder layers (that are sintered later to become the blocking layers) formed or disposed (attached) between the plurality of partial oxide felt assemblies and press the plurality of partial oxide felt assemblies and the oxide powder layers so that interface bonding may be more smoothly performed, at the time of performing the co-sintering. The pressing increases a shrinkage amount in the thickness direction at the time performing the co-sintering, and thus is a preferable method in terms of formation of the dense blocking layer. In order to control a final thickness of the entire gasket completed after the co-sintering, it is preferable that the final thickness of the gasket may be controlled by installing a stopper having a desired thickness.

In order to manufacture the gasket, several-fold oxide felts are cut so that a gasket having a desired width may be formed, and are then bonded to one another using the organic adhesives such as adhesives that are removable by thermal decomposition and oxidation in the co-sintering process to manufacture the oxide felt assembly.

In addition, the oxide felt assembly is cut in the length direction of the gasket (cut in a height direction of the stack at the time of mounting the gasket on the stack). That is, the oxide felt assembly is cut so that the cut surfaces may be perpendicular to a migration direction of the molten carbonate. In other words, the oxide felt assembly is cut in a direction parallel with the stacking direction of the stack. In the present disclosure, this is referred to as the partial oxide felt assembly for convenience so as to be distinguished from the oxide felt assembly. In this case, a length of the partial oxide felt assembly is controlled depending on the number of blocking layers that are to be formed in the entire gasket. In other words, as the length of one partial oxide felt assembly becomes short, the number of blocking layers formed in the entire gasket is increased.

Next, a method of forming or disposing (or attaching) oxide-based blocking layers having the same composition and crystal structure as those of the oxide felt on (or to) the cut surfaces of the partial oxide felt assemblies is described. The blocking layers may be formed by manufacturing suspension of the oxide powder particles having the same composition and crystal structure as those of the oxide felt and then applying or spraying the suspension to the cut surfaces of the manufactured partial oxide felt assemblies. As another method, there is a method of manufacturing a paste of the oxide powder particles having a predetermined viscosity and then applying the paste to the cut surfaces of the manufactured partial oxide felt assemblies. As another method, a method of stacking green sheets of the oxide powder particles at an appropriate thickness by a method such as tape casting, extruding, or the like, to manufacture an oxide powder green sheet laminate and disposing or attaching the green sheet laminate tailored depending on a size of the cut surfaces of the partial oxide felt assemblies between the partial oxide felt assembly and the oxide felt assembly may be used.

A shape of the blocking layers, a form in which the blocking layers are disposed between the partial oxide felt assemblies, and the like, are not particularly limited.

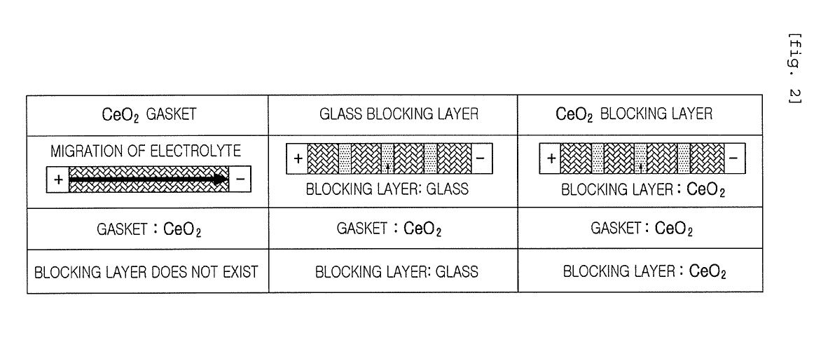

In FIG. 2, a structure of the gasket in which the blocking layers are inserted between the partial gaskets is schematically illustrated. As illustrated in FIG. 2, the blocking layers may be disposed in parallel with a stacking surface of the stack, and may have a predetermined gradient. However, the blocking layers are not limited thereto, but may have various shapes depending on a method of cutting the oxide felt assembly.

Particularly, in the present disclosure, a load is applied to the partial oxide felt assemblies and the blocking layers so that the partial oxide felt assemblies and the blocking layers may be robustly bonded to each other in the co-sintering process. In this case, it is preferable to manufacture the partial oxide felt assemblies by cutting the oxide felt assembly to have an inclination with respect to the length direction of the gasket rather than cutting the oxide felt assembly perpendicularly to the length direction of the gasket in a process of manufacturing the partial oxide felt assemblies by cutting the oxide felt assembly so that the load may be more effectively transferred to bonding surfaces between the partial oxide felt assemblies and the blocking layers. In other words, it is preferable to manufacture the partial oxide felt assemblies by cutting the oxide felt assembly to have an inclination with respect to the stacking direction of the stack rather than cutting the oxide felt assembly in accurately parallel with the stacking direction of the stack.

An interval between the blocking layer may be appropriately controlled in a range in which a problem due to the electrolyte lack of the positive electrode end cell and the electrolyte excess of the negative electrode end cell is not caused within the stack (a partial stack) in a region in which one partial gasket, that is, a partial gasket separated by one blocking layer and a blocking layer adjacent to one blocking layer is in contact with the stack, when considering a function for preventing a performance decrease due to the electrolyte lack of the positive electrode end cell and the electrolyte excess of the negative electrode end cell caused by the migration of the molten carbonate electrolyte through the porous gasket.

Therefore, separation of the gasket and the number of blocking layers inserted between the partial gaskets depending on the separation of the gasket are not particularly limited, but for example, one blocking layer may be separately provided per unit cell or one blocking layer may be provided per various numbers of unit cells such as 2, 3, 5, 7, 10, and the like.

As another implementation, it is advantageous that the interval between the blocking layers becomes narrow since an electrolyte migration suppressing effect is increased as a length of each of the partial gaskets becomes short, that is, the number of inserted blocking layers is increased, but it is preferable to optimize the interval between the blocking layers in consideration of convenience in a process of manufacturing the gasket. In terms thereof, it is preferable that the length of the partial gasket is 2 to 5 cm. However, even though the number of blocking layers is only one, when the blocking layer exists, the electrolyte migration amount is decreased as compared to the gasket according to the related art in which the blocking layer does not exist at all, and the number of blocking layers and the interval between the blocking layers are thus not particularly limited.

The gasket manufactured by the method as described above and having the blocking layers is attached to a dielectric material, the gasket and the dielectric are disposed between the external manifold and the stack, and a surface pressure is applied to the gasket and the dielectric, such that the gasket may be deformed to obtain the manifold sealing part of the external manifold-type MCFC while being closely adhered between the stack and the insulator.

As a material of the dielectric, a generally used material may be appropriately used in the present disclosure. For example, the dielectric formed of alumina may be used.

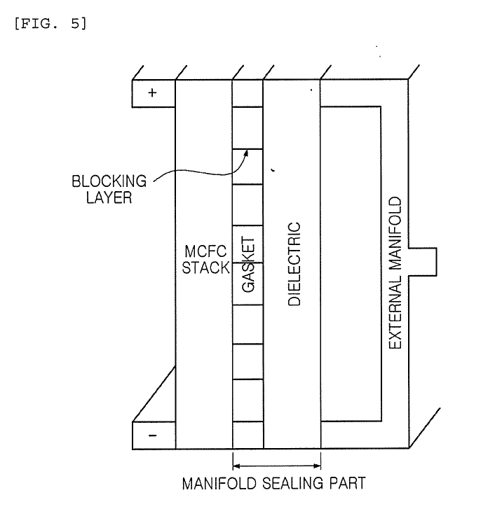

A sealing concept of an MCFC manifold to which a sealing part including gaskets having electrolyte migration-blocking layers according to the present disclosure is applied is illustrated in FIG. 5. The sealing part to which the gasket including the blocking layers according to the present disclosure is applied is provided, such that a phenomenon in which the molten carbonate electrolyte impregnated in the matrix migrates from the cathode toward the anode through the gasket is suppressed by the blocking layers. Therefore, a performance decrease and generation of the leakage of the gas due to the electrolyte lack of the positive electrode end cell of the fuel cell and the electrolyte excess of the negative electrode end cell of the fuel cell may be prevented.

In order to test an effect of the electrolyte migration-blocking layers according to the present disclosure, a test was performed as follows.

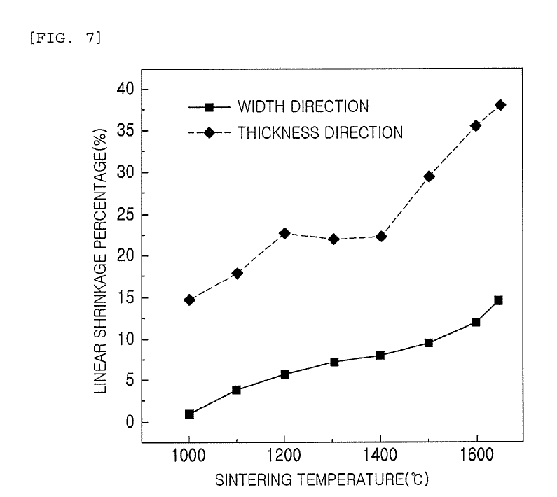

First, in order to integrate and co-sinter the blocking layers and the gasket, a final sintering-shrinkage percentage and shrinkage behavior at each temperature of CeO₂, a base material, need to be recognized. To this end, a result as illustrated in FIG. 7 was obtained by evaluating sintering-shrinkage percentages, in the width and thickness directions, of CEF-100, a CeO₂ felt manufactured by Zircar Zirconia Inc. of the United States.

Since the final sintering-shrinkage percentage at the time of performing heat treatment at 1650° C. for two hours is 15% in the width direction and is 38% in the thickness direction, it was decided that a CeO₂ layer formed on the oxide felt laminate may be sufficiently integrated with a CeO₂ gasket by the co-sintering.

### Inventive Example 1

A CeO₂ felt assembly was manufactured by cutting a CeO₂ felt (CEF-100) manufactured by Zircar Zirconia Inc. of the United States at a width of 60 mm and a length of 300 mm, applying a spray adhesive to a surface of the CeO₂ felt, and overlapping these five CeO₂ felts with one another. The laminate was cut at an interval of 20 mm in an oblique line direction of 45 degrees with respect to the length direction, and a paste of CeO₂ powder particles was applied to the cut surfaces. An oxide felt assembly was formed by connecting the oblique (45 degrees) cut surfaces of the partial CeO₂ felt assemblies to one another. A CeO₂ gasket was manufactured by performing heat treatment at 1650° C. for two hours while applying a load of about 5 g/cm² to the oxide felt assembly. A final thickness of the manufactured gasket was controlled using an alumina stopper of 6 mm.

### Comparative Example 1

A CeO₂ gasket was manufactured by overlapping five CeO₂ felts (CEF-100) manufactured by Zircar Zirconia Inc. of the United States with one another, applying a load of about 5 g/cm² to the overlapping five CeO₂ felts, and performing heat treatment at 1650° C. for two hours. A final thickness of the manufactured gasket was controlled using an alumina stopper of 6 mm.

(Comparison Between Electrolyte Migration Levels)

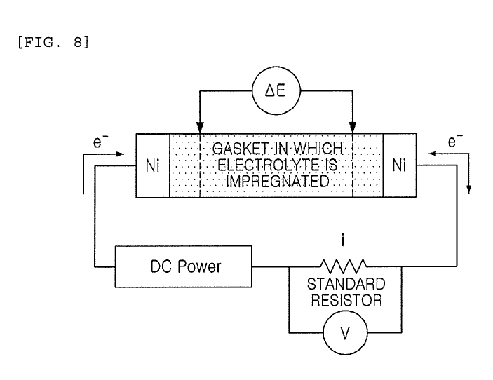

Electrolyte migration levels of the gasket according to Inventive Example 1 and the gasket according to Comparative Example 1 were compared with each other and evaluated by configuring a test method as illustrated in FIG. 8. After molten carbonate of the same ratio is impregnated in the gasket according to Inventive Example 1 and the gasket according to Comparative Example 1, current densities flowing through a standard resistor by applying a potential difference of 0.5V/cm to the gasket according to Inventive Example 1 and the gasket according to Comparative Example 1 were relatively compared with each other. Since the shunt current is in proportion to an electrolyte migration amount by the potential difference, a relative comparison for an electrolyte migration amount decreasing effect according to Inventive Example 1 is possible.

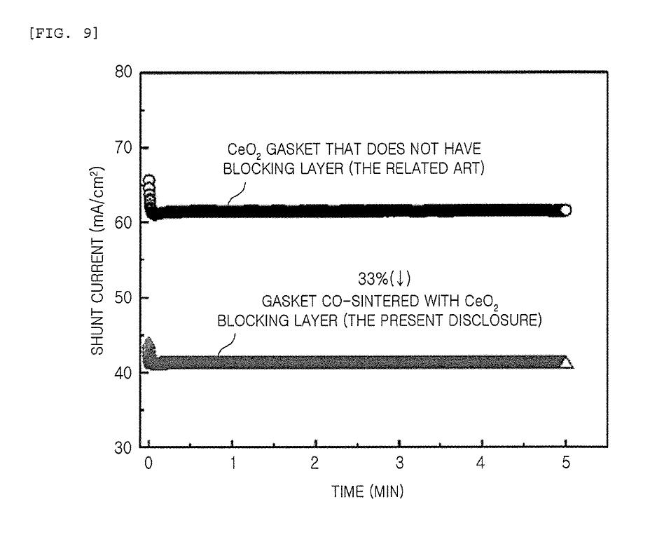

According to the test result illustrated in FIG. 9, it may be confirmed that an electrolyte migration amount is decreased by about 33% in the gasket including the CeO₂ blocking layers according to Inventive Example 1 as compared to the existing CeO₂ gasket.

While exemplary embodiments have been shown and described above, it will be apparent to those skilled in the art that modifications and variations could be made without departing from the scope of the present invention as defined by the appended claims.

1. A gasket for an external manifold-type molten carbonate fuel cell,
wherein the gasket has a structure in which two or more partial gaskets separated from each other in a stacking direction of a stack are connected to each other, and has a structure in which a blocking layer physically blocking migration of a molten carbonate electrolyte is interposed between the partial gaskets.

2. The gasket for an external manifold-type molten carbonate fuel cell of claim 1, wherein the blocking layer is an oxide-based blocking layer having the same composition and crystal structure as those of the partial gasket.

3. The gasket for an external manifold-type molten carbonate fuel cell of claim 1, wherein the blocking layer is installed in a direction perpendicular to a length direction of the gasket or is installed to have an inclination with respect to the length direction of the gasket.

4. The gasket for an external manifold-type molten carbonate fuel cell of claim 1, wherein the partial gasket has a length of 2 to 5 cm.

5. The gasket for an external manifold-type molten carbonate fuel cell of claim 1, wherein the blocking layer has a thickness of 0.1 to 0.3 mm.

6. A method of manufacturing a gasket by sintering oxide felt materials, comprising:
manufacturing an oxide felt assembly by cutting oxide felts at an appropriate width and stacking and bonding the cut oxide felts to one another;
manufacturing partial oxide felt assemblies by cutting the oxide felt assembly perpendicularly to a length direction of the gasket or cutting the oxide felt assembly to have an inclination with respect to the length direction of the gasket;
disposing blocking layers on cut surfaces of the partial oxide felt assemblies; and
connecting a plurality of partial oxide felt assemblies on which the blocking layers are formed to one another and co-sintering entirety of the connected partial oxide felt assemblies.

7. The method of claim 6, wherein the co-sintering is performed under an atmosphere in a range of 1600 to 1650° C.

8. The method of claim 6, wherein the blocking layer is a thick film or a green sheet using powder particles.

9. The method of claim 6, wherein the blocking layer is an oxide having the same composition and crystal structure as those of the oxide felt.

10. The method of claim 9, wherein the oxide is alumina (Al₂O₃), LiAlO₂, yttria-doped zirconia (Y₂O₃-doped ZrO₂), or CeO₂.

11. The method of claim 9, wherein the oxide is ceria (CeO₂).

12. The method of claim 8, wherein a particle size of the powder particles is 0.5 μm to 3 μm in terms of an average particle size.

13. The method of claim 6, wherein the co-sintering is performed in a state in which a load is applied to the partial oxide felt assemblies.
